(19) United States
(12) Patent Application Publication
(10) Pub. No.: US 2018/0258910 A1
(43) Pub. Date: Sep. 13, 2018

(54) Horizontal Axis Wind Turbine

(71) Applicant: Sauer Energy, Inc., Oxnard, CA (US)

(72) Inventors: Dieter R. Sauer, JR., Oxnard, CA (US); James Michael Hubbard, Newbury Park, CA (US)

(73) Assignee: Sauer Energy, Inc., Oxnard, CA (US)

(21) Appl. No.: 15/453,900

(22) Filed: Mar. 8, 2017

(51) Int. Cl. F03D 1/06; F03D 13/20; F03D 80/70; F03D 7/02

(52) U.S. Cl. CPC F03D 1/0658; F03D 13/20; F03D 80/70; F05B 2260/902; F05B 2240/221; F05B 2240/912; F05B 2220/706; F03D 7/0248

(57) ABSTRACT

An apparatus for converting wind energy into electrical energy includes a turbine having a horizontal shaft, a plurality of blades, a blade mount supporting the blade assembly for rotation about the horizontal shaft, and a turbine mount supporting the turbine for rotation about a vertical axis. The blade mount includes a pair of spaced part annular face plates, with a bearing mounted at the opening of each plate. The proximal end of each blade is secured within an airfoil-shaped opening in a mounting block extending between the two face plates. A disc extending from the back of the rear face plate encircles the generator and cooperates with a piston and caliper assembly to function as a brake. The turbine mount includes a connector plate coupled to the turbine, a connector ring connected to the tower, and a pair of bearings mounted above and below the connector ring.

### TECHNICAL FIELD

The present disclosure relates in general to turbines for converting wind energy into electrical energy and more particularly to a horizontal axis wind turbine.

### BACKGROUND

Wind turbines generally fall into two categories: horizontal axis and vertical axis. A horizontal axis wind turbine is mounted on a vertical tower, and includes a blade assembly that rotates about a horizontal axis to turn the rotor of an electrical generator. Because the blade assembly must always be pointed into the wind, a wind vane or servo motor is provided for rotating the turbine about the longitudinal axis of the tower. A vertical axis wind turbine has a vertical rotor shaft and does not need to be pointed into the wind.

Horizontal axis wind turbines have higher rotational speeds, and are generally more efficient and more commonly used than vertical axis wind turbines. However, the high rotational speeds result in high stresses on the blades, bearings, and gearboxes of these types of wind turbines, which can lead to cracking and failure of components. This in turn can lead to high maintenance and repair costs, and unacceptable down times.

The above problems are addressed by this disclosure as summarized below.

### SUMMARY

An apparatus for converting wind energy into electrical energy includes a turbine having a horizontal shaft, a plurality of blades, a blade mount supporting the blade assembly for rotation about the horizontal shaft, and a turbine mount supporting the turbine for rotation about a vertical axis.

In one aspect of the disclosure, the blade mount includes a pair of spaced apart face plates encircling the shaft. A plurality of mounting blocks extends between the plates. Each mounting block includes an opening for receiving a blade. In a preferred embodiment, each mounting block includes two spaced apart mounting plates, each having an opening. The opening in one of the plates receives a proximal portion of the blade, and the opening in the other plate receives the blade distally of the first opening. Each of the blades preferably has an airfoil-shaped cross section, and each of the openings in the mounting blocks has an airfoil-shaped perimeter matching the cross-section of the corresponding blade.

In another aspect of the disclosure, the face plates include a front face plate defining a first bore and a rear face plate defining a second bore coaxial with said first bore. The first bearing assembly includes a front bearing coupled to the front face plate and a rear bearing coupled to the rear face plate. The front and rear bearings support the horizontal shaft for rotation within the first and second bores.

In still another aspect of the disclosure, a disc is integrally connected to the rear face plate by at least one bar extending perpendicularly to the rear face and the disc. A piston and caliper assembly cooperates with the disc to function as a brake stopping or slowing rotation of the blades when necessary. In another aspect, the disc is annular and encircles the generator.

In yet another aspect of the disclosure, the turbine is connected to a vertical tower by a turbine mount including a connector plate coupled to the turbine and a connector ring connected to the tower. A pair of bearings, including an upper bearing above the connector ring and a lower bearing below the connector ring, supports the vertical shaft for rotation within the connector ring. An end cap may be coupled to the connector plate and to a lower end of the vertical shaft for rotation therewith, wherein the lower bearing is sandwiched between the end cap and the connector ring.

### BRIEF DESCRIPTION OF THE DRAWINGS

FIG. 1 is a perspective view showing the apparatus of the present disclosure

FIG. 2 is an exploded perspective view showing the basic elements of a wind turbine according to the present disclosure, with the nose cone and nacelle removed for purposes of illustration.

FIG. 3 is a fragmentary perspective view from the left and front of the wind turbine of FIGS. 1 and 2.

FIG. 4 is a perspective view from the left of a blade mount according to the present invention.

FIG. 5 is a perspective view from the left and rear of the blade mount of FIG. 4, with the blades removed for purposes of illustration.

FIG. 6 is a fragmentary perspective view from the right and rear of the wind turbine of FIGS. 1-3.

FIG. 7 is an exploded perspective view showing the elements of a turbine mount according to the present invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

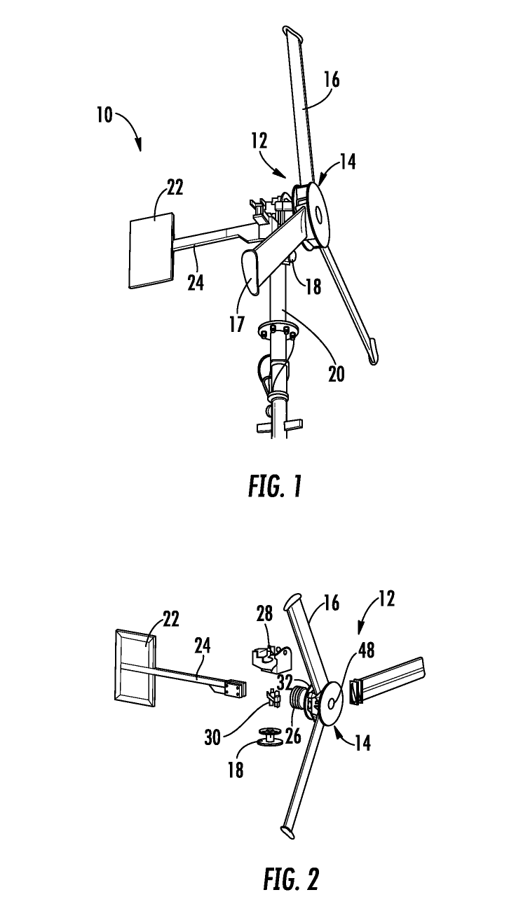

An apparatus for converting wind energy into electrical energy, indicated in its entirety in FIG. 1 by the numeral 10, includes a wind turbine 12 having a blade mount 14 that supports a plurality of blades 16 for rotation about a horizontal shaft. Each blade 16 is designed for maximum aerodynamic efficiency, and has an airfoil-shaped cross section. A winglet 17 having substantially the same airfoil shape as the cross-section of its corresponding blade 16, but a larger surface area than the cross-section of the blade 16 is provided on the end of each blade. In the illustrated embodiment, the blades are three in number, each having a concave pressure side and a convex suction side. However, the number and shape of the blades may vary depending on application, without departing from the spirit of this disclosure.

A nose cone 19 in front of the blade mount 14 and a nacelle 21 to the rear of the blade mount 14 give the turbine a streamlined geometry that reduces sound and minimizes drag, resulting in optimal aerodynamic performance. A turbine mount 18 connects the turbine 12 to a vertical tower or pole 20 and allows the turbine to rotate about a vertical axis in response to forces exerted by the wind on a yaw vane 22 mounted on an elongated tail 24 extending from the back of the turbine 12. This ensures that the blades 16 face into the wind for maximum output.

The nacelle 21 encases a generator 26, seen in FIG. 2, that converts the kinetic energy of the rotating blades 16 into electrical energy. A gear box 28 steps up the speed of the generator 26. The blades 16 are prevented from reaching excessively high rotational speeds by a braking mechanism comprising a piston and caliper assembly 30 that cooperates with a disc 32 integrally connected to the blade mount 14.

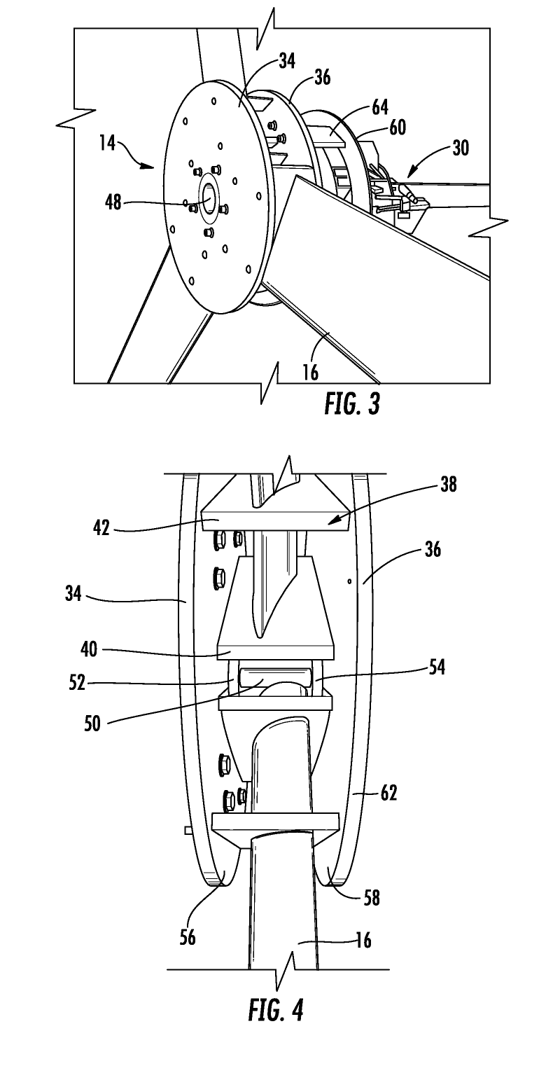

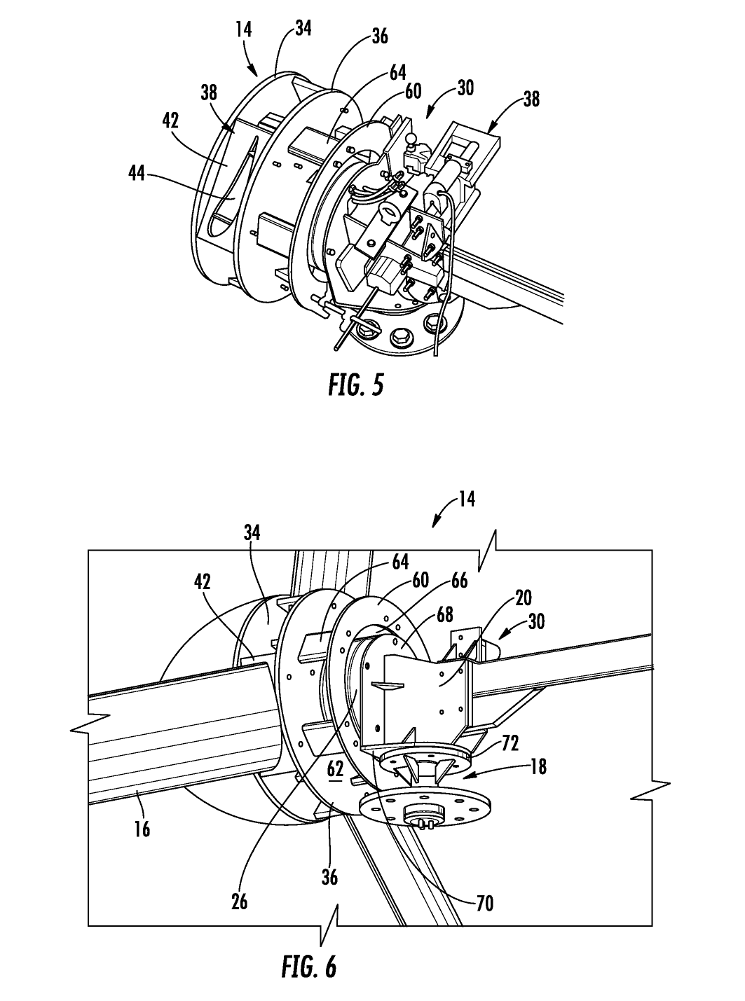

The blade mount 14, shown in greater detail in FIGS. 3-6, includes a pair of circular face plates 34, 36 that are connected in spaced relationship to one another by a set of mounting blocks 38. As best seen in FIGS. 4 and 5, each mounting block 38 is actually a pair of spaced apart mounting plates 40, 42, each of which defines an opening 44 having an airfoil-shaped perimeter that matches the airfoil-shaped cross section of the blades 16a, 16b, 16c. During assembly, the blades 16 are press-fit into the openings 44 in the mounting plates such that the opening 44 in one mounting plate 40 of every pair closely surrounds the corresponding blade 16 at a first location near the proximal end 46 of the blade, and the opening 44 in the other mounting plate 42 closely surrounds the blade 16 at a second location distal to the first location. This double-support mounting arrangement stabilizes the blades 16 so they are better able to sustain the high stresses resulting result from high rotation speeds, and may also reduce vibration.

Each of the face plates 34, 36 includes a central bore 48. A horizontal shaft 50, best seen in FIG. 4, extends through the aligned bores 48 in the face plates 34, 36. The blade mount 14 is supported for rotation about the shaft 50 by a pair of bearings 52, 54 that concentrically surround the bores 48 in the face plates 34, 36. The front bearing 52 projects rearwardly from the rear side 56 of the front face plate 34, while the rear bearing 54 projects forwardly from the front side 58 of the rear face plate 36.

An annular disc 60, best seen in FIGS. 3, 5, and 6, is integrally coupled to the rear side 62 of the rear face plate 36 by a plurality of mounting bars 64 that extend perpendicularly between the rear face plate 36 and the annular disc 60. Piston and caliper assembly 30 cooperates with the annular disc 60 to function as a brake stopping or slowing rotation of the blades when rotation speeds become excessive. In some embodiments, a second piston and caliper assembly may be added on the opposite side of the disc 60 to provide more effective braking action.

The central opening 66 of the annular disc 60 concentrically surrounds the generator 26, which is secured on its rear side to an enlarged flange 68 at the front end of the housing 69 of the gearbox 28. Together, the rear face plate 36, annular disc 60 and mounting bars 64 define a cage or enclosure that substantially protects and stabilizes the generator 26.

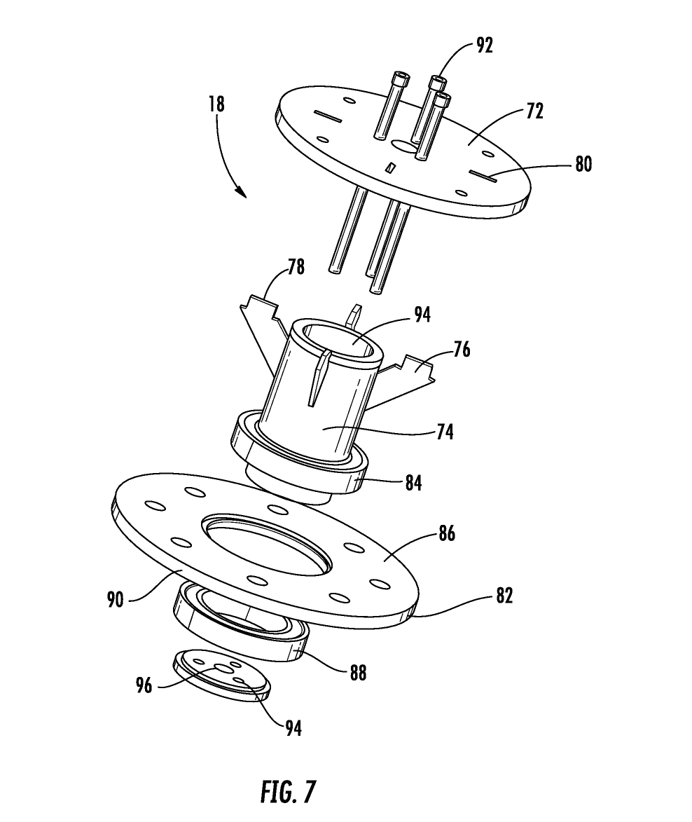

A second enlarged flange 70 extending at a right angle from the lower end of enlarged flange 68 serves as an attachment surface to which a circular connector plate 72 at the top end of the turbine mount 18 is bolted or otherwise secured. As best seen in FIG. 7, the connector plate 72 is secured to a tubular vertical shaft 74 by a number of arms 76 that slant upwardly and outwardly from the shaft 74. A tab 78 at the upper end of each arm is received in a mating slot 80 in the connector plate 72. The vertical shaft 74 is supported for rotation within in a connector ring 82 by a pair of bearings including an upper bearing 84 disposed on the upper side 86 of the connector ring 82 and a lower bearing 88 disposed on the lower side 90 of the connector ring 82. The connector ring 82 of the turbine mount 18 is bolted or otherwise secured to the top of the pole or tower 20 shown in FIG. 1.

A plurality of elongated fastening rods or bolts 92 extend through the connector plate 72 and the bore 94 of vertical shaft 74. The threaded lower ends of the bolts 92 are received in mating threaded holes in an end cap 96 that holds the elements of the turbine mount 18 together in a compact and stable arrangement.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An apparatus for converting wind energy to electrical energy, comprising:
a turbine including
a horizontal shaft,
a plurality of blades, and
a blade mount supporting said blades for rotation about said horizontal shaft; and
a turbine mount supporting said turbine for rotation about a vertical axis.

2. The apparatus according to claim 1, wherein the blade mount comprises:
a pair of spaced apart face plates encircling the shaft,
a plurality of mounting blocks extending between the face plates,
each of the mounting blocks including an opening; and
a blade secured within the opening of each of the mounting blocks.

3. The apparatus according to claim 2, wherein each of the mounting blocks includes:
a first mounting plate having a first opening receiving a proximal end of one of the blades, and
a second mounting plate proximally spaced from the first mounting plate, and having a second opening receiving the blade distally of the first opening.

4. The apparatus according to claim 3, wherein each of the blades has an airfoil-shaped cross-section, and each of the openings has an airfoil-shaped perimeter matching the cross-section of the corresponding blade.

5. The apparatus according to claim 1, wherein:
the apparatus includes a vertical tower; and
the turbine mount includes
a connector ring secured to the vertical tower, and
a vertical shaft coupled to the turbine;
wherein the turbine mount supports the vertical shaft for rotation within the connector ring.

6. The apparatus according to claim 5, wherein the turbine mount further comprises a connector plate coupled to the turbine and secured to an upper end of the vertical shaft for rotation therewith.

7. The apparatus according to claim 6, wherein the turbine mount includes an upper bearing and a lower bearing, wherein the connector ring is sandwiched between the upper and lower bearings.

8. The apparatus according to claim 7, further comprising an end cap coupled to the connector plate and to a lower end of the vertical shaft for rotation therewith, wherein the lower bearing is sandwiched between the end cap and the connector ring.

9. The apparatus according to claim 2, wherein the blade mount further comprises:
an annular disc parallel to and rotatable with the face plates;
a piston and caliper assembly cooperating with the disc to function as a brake stopping or slowing rotation of the blades.

10. The apparatus according to claim 9, wherein:
the face plates comprise a front face plate and a rear face plate; and
the annular disc is integrally coupled to the rear face plate by at least one bar extending perpendicularly between the rear face plate and the disc.

11. The apparatus according to claim 10, wherein:
the turbine includes a generator; and
the generator is positioned between the rear face plate and annular disc, and encircled by the annular disc.

12. The apparatus according to claim 2, wherein:
the face plates include
a front face plate having a first bore extending therethrough,
a rear face plate having a second bore coaxial with said first bore; and
the blade mount further includes
a front bearing coupled to the front face plate, and
a rear bearing coupled to the rear face plate;
wherein the front and rear bearings support the horizontal shaft for rotation within the first and second bores.

13. A wind turbine comprising:
a horizontal shaft;
a plurality of blades; and
a blade mount including
a front face plate having a first bore extending therethrough,
a rear face plate having a second bore coaxial with said first bore, and
a plurality of mounting blocks extending between the face plates, each mounting block including an opening; and
a blade secured within the opening of each of the mounting blocks; and
a bearing assembly supporting said shaft for rotation within the first and second bores.

14. The wind turbine according to claim 13, wherein the bearing assembly comprises:
a front bearing coupled to the front face plate, and
a rear bearing coupled to the rear face plate;
wherein the front and rear bearings support the horizontal shaft for rotation within the first and second bores.

15. The wind turbine according to claim 13, wherein each of the mounting blocks includes:
a first mounting plate having a first opening receiving a proximal end of one of the blades, and
a second mounting plate proximally spaced from the first mounting plate, and having a second opening receiving the blade distally of the first opening.

16. The wind turbine according to claim 15, wherein each of the blades has an airfoil-shaped cross-section, and each of the openings has an airfoil-shaped perimeter matching the cross-section of the corresponding blade.

17. The wind turbine according to claim 13, wherein the blade mount further comprises:
a disc parallel to and rotatable with the face plates;
a piston and caliper assembly cooperating with the disc to function as a brake stopping or slowing rotation of the blades.

18. The wind turbine according to claim 17, wherein the disc is integrally coupled to the rear face plate by at least one bar extending perpendicularly between the rear face plate and the disc.

19. An apparatus for converting wind energy to electrical energy, comprising:
a vertical tower;
a turbine including a plurality of blades mounted for rotation about a horizontal axis;
a turbine mount connecting the turbine to the vertical tower, the turbine mount including
a connector ring secured to the vertical tower, and
a vertical shaft coupled to the turbine;
a connector plate coupled to the turbine and secured to an upper end of the vertical shaft for rotation therewith; and
a bearing assembly supporting the turbine for rotation about a vertical axis, the bearing assembly including an upper bearing disposed above the connector ring and a lower bearing disposed below the connector ring, wherein the upper and lower bearings support the vertical shaft for rotation within the connector ring.

20. The apparatus according to claim 18, further comprising an end cap coupled to the connector plate and to a lower end of the vertical shaft for rotation therewith, wherein the lower bearing is sandwiched between the end cap and the connector ring.
